(19) United States
(12) Patent Application Publication
(10) Pub. No.: US 2015/0322318 A1
(43) Pub. Date: Nov. 12, 2015

(54) FUNGICIDE SILICON SEALING COMPOUND

(71) Applicant: LANXESS DEUTSCHLAND GMBH, Cologne (DE)

(72) Inventors: Hermann UHR, Leverkusen (DE); Andreas BOETTCHER, Cologne (DE); Katrin MOEWS, Dortmund (DE)

(21) Appl. No.: 14/648,443

(22) PCT Filed: Dec. 17, 2013
(86) PCT No.: PCT/EP2013/076937

§ 371 Date: May 29, 2015

(30) Foreign Application Priority Data
Dec. 17, 2012 (EP) 12197429.9

(51) Int. Cl. C09K 3/10; A01N 25/10; A01N 25/28; A01N 43/653

(52) U.S. Cl. CPC C09K 3/10; A01N 43/653; A01N 25/10; A01N 25/28; C09K 2200/0685; C09K 2200/0476

(57) ABSTRACT

The present invention relates to protection of silicone sealing compounds from destruction by fungal mould with the aid of microencapsulated fungicides, and also to a process for producing microencapsulated fungicides and to the use of the microencapsulated fungicides for protection of silicone sealing compounds. The invention further relates to formulations of the microencapsulated fungicides which assure easy incorporation into the sealing compounds.

The present invention relates to protection of silicone sealing compounds from destruction by fungal mould with the aid of microencapsulated fungicides, and also to a process for producing microencapsulated fungicides and to the use of the microencapsulated fungicides for protection of silicone sealing compounds. The invention further relates to formulations of the microencapsulated fungicides which assure easy incorporation into the sealing compounds.

Sealants are materials which are utilized for sealing of joins, gaps, apertures or the like. Sealants, particularly those based on silicone, are frequently affected by fungal mould, which can make use of the degradation of the sealants, for example the cleavage products and by-products present therein or adsorbed residues such as alcohols or organic acids, or adhering impurities such as soap residues, for its own metabolism. Since the seals are frequently exposed to water and moisture, they have a tendency to be colonized by fungal mould after only a short time. After a short time, this leads to discolouration of the sealing compound, and the discolouration can be removed only with difficulty. As well as the optical change, the functioning of the sealing compounds as sealing material can also be disrupted. In addition, the fungi can also lead to health problems, firstly resulting from the fungal spores themselves, and also from secondary substances secreted by the fungi, some of which can lead to odour nuisance or even to severe allergic reactions. This is of particular relevance for one-component silicone rubber mixtures, called RTV-1 compounds hereinafter, since they are the most commonly used sealant type in the sanitary sector. Fungicides already being used commercially in sealants include various chemical compound classes, for example benzimidazoles, isothiazolines or else azoles.

For example, JP 2876068 describes water-repellent organosilicones modified with thiabendazole to counter mould. U.S. Pat. No. 4,247,442 also describes specific organopolysiloxanes which have been protected against mould with thiabendazole. A disadvantage of the aforementioned mixtures is that they do not give adequate long-term protection of the silicone scaling compounds against microorganisms. If the active ingredient is incorporated directly into the sealing compounds, it is washed out of the sealing compounds relatively easily on contact with water, which leads to a shortened duration of action, particularly in the sanitary sector. This effect occurs particularly in the neutral-crosslinked RTV-1 systems.

WO 2006/056266 describes mould-resistant building materials, including silicone sealing compounds, which have the feature that they contain a triazolyl compound, for example tebuconazole, optionally in combination with a sporulation inhibitor and/or with an active substance which is anti-adhesive with respect to microorganisms. In addition, WO 2006/056266 states that different carrier materials can be used for the triazolyl compound, especially silicic esters of azole compounds. A disadvantage of these mixtures too is additionally that fungicides are subject to significant leaching in neutral-crosslinked RTV-1 silicone sealing compounds and, therefore, there is no long-term protection of the RTV-1 silicone sealing compounds against fungal mould.

WO 2008/080963 describes various silicone sealing compounds in which the washout of the biocidal active ingredients is to be prevented. They contain, as biocidal active ingredients, N-octylisothiazolinone or dichloro-N-octylisothiazolinone or alkylbenzisothiazolinones and optionally further biocides, the biocidal active ingredient having been incorporated into microcapsules of an amino resin. EP 1884542 discloses biocides likewise encapsulated by polymers for protection of RTV-1 silicone scaling compounds. The biocides used are also N-octylisothiazolinone and dichloro-N-octylisothiazolinone. The mixtures and methods for protection of silicone sealing compounds described in these documents also have the disadvantage that it was not possible to achieve long-term protection of the silicone sealing compounds against mould.

There was therefore a continuing need for compounds or mixtures which enable long-term and effective protection of silicone sealing compounds against mould.

It has been found that, surprisingly, mixtures of silicone sealing compounds with selected fungicides which have been microencapsulated by melamine-formaldehyde resin have a high biological activity and low leaching, and as a result give high long-term protection of silicone sealing compounds against mould.

The invention therefore relates to silicone sealing compounds modified with at least one microencapsulated fungicide, wherein the fungicide is selected from the group of tebuconazole, propiconazole, thiabendazole and mixtures of these fungicides, and the fungicide has been encapsulated with at least one melamine-formaldehyde polymer.

The scope of the invention encompasses all parameters and elucidations above and detailed hereinafter, in general terms or mentioned within areas of preference, together with one another, i.e. including any combinations between the respective areas and areas of preference.

The silicone sealing compounds are all silicones which cure chemically through air humidity or water, for example acetate silicones, amine/amineoxy silicones, benzamide silicones, oxime silicones or alkoxy silicones.

They are preferably room temperature crosslinking systems, as disclosed, for example, in U.S. Pat. No. 5,077,360 or EP 0327847.

The systems may also be multicomponent systems in which catalyst and crosslinker may be present separately, for example U.S. Pat. No. 4,891,400, U.S. Pat. No. 5,502,144 or other so-called silicone RTV-2 systems, especially platinum-free systems.

However, preference is given to one-component systems. This is understood to mean systems as described in J. R. Panek and J. P. Cook, see above, p. 168 ff. and Ullmann's Encyclopedia of Industrial Chemistry, sixth Ed. 2001 Electronic Release Chapter 5. These systems contain, as well as all the constituents necessary for formation of a sealing compound, for example fillers, solvents and additives, a polyorganosiloxane and hydrolysis-sensitive crosslinker components. The vulcanization is effected in the presence of moisture. A distinction is made between acidic, basic and neutral systems (silicone neutral systems). Acidic systems contain, for example, methyltriacetoxysilane as crosslinker and release acetic acid in the course of vulcanization. Basic systems release small amounts of an amine in the course of vulcanization.

Very particular preference is given to neutral-crosslinking RTV-1 silicone sealing compounds. The RTV-1 silicone sealing compounds are understood to mean one-component systems which are vulcanized at room temperature under the influence of air humidity to give an elastic rubber. In contrast to the RTV-2 silicone sealing compounds, the RTV-1 silicone sealing compounds are usable immediately, and there is no need to add any further component for vulcanization. The neutral-crosslinking RTV-1 silicone sealing compounds release small amounts of an oxime or alcohol in the course of vulcanization. In the case of these, the reaction of crosslinkers with the water in the ambient air therefore does not lead to corrosive acidic, basic or odorous cleavage products. Even more preferred are neutral-crosslinking RTV-1 silicone sealing compounds in which oximes are eliminated during the vulcanization.

In the context of the present invention, “microencapsulated” or “encapsulated” means that the active ingredient, i.e. the fungicides, is encapsulated by a generally semipermeable capsule wall, or the active ingredient may also be at least partly mixed with the capsule wall. The capsule wall consists here, in addition to residues of solvent, crosslinkers and further auxiliaries, of the polymer. The ratio of capsule wall and incorporated active ingredient may vary within a wide range, and may be adapted to the particular active ingredient and the particular sealing compound to be protected.

In general, the weight ratio (w/w) of the amount of polymers to incorporated active ingredient is 1:100 to 3:1, preferably 1:30 to 1:1 and most preferably 1:19 to 1:2 and even further preferably 1:6 to 1:2. In general, the weight ratio (w/w) of the amount of melamine-formaldehyde resin to incorporated fungicide is 1:100 to 3:1, preferably 1:30 to 1:1 and most preferably 1:19 to 1:2 and even further preferably 1:6 to 1:2.

In general, the amount of active ingredient in the microencapsulated fungicides is 50% by weight to 95% by weight, preferably 65% by weight to 85% by weight, based on the total amount of microencapsulated fungicide.

However, the scope of the invention also includes those “capsules” in which the capsule wall is incomplete or has pores, or the active ingredient is distributed with greater or lesser homogeneity in the capsule material. In the context of the invention, therefore, the term “encapsulated fungicide” means that the fungicide may be incorporated within the capsule or else may be partly mixed with the capsule wall.

The encapsulation material must contain at least melamine-formaldehyde polymer. The melamine-formaldehyde polymers are resins. The melamine-formaldehyde resins may also contain further encapsulation materials made from amino resins. Amino resins are generally understood to mean polycondensation products of carbonyl compounds (particularly formaldehyde, but also higher carbonyl compounds) with compounds containing NH groups.

Further possible amino resins which may be added to the melamine formaldehyde resins include, for example, formaldehyde-urea resins, urethane resins, cyanamide resins or dicyanamide resins, aniline resins and sulphonamide resins, aminoplast or mixtures of these resins. In general, up to 50% of other aminoplasts may be added to the melamine-formaldehyde resin. Preferably, the encapsulation material, however, consists at least to an extent of 95% of melamine-formaldehyde polymer, more preferably, the encapsulation material consists to an extent of 99% of melamine-formaldehyde polymer. The remaining residues may originate, for example, from solvents, the crosslinkers or further auxiliaries.

The preparation of the melamine-formaldehyde microcapsules used comprises the use of water-soluble melamine-formaldehyde prepolymers which precipitate on the active ingredients and are cured as a result of changing pH, and thus form the capsule wall. The melamine-formaldehyde prepolymers are commercially available, for example Saduren (BASF AG), Maprenal (Ineos Melamines), Quecodur (Thor GmbH) or else can be prepared from melamine and formaldehyde by known methods.

General processes for production of microcapsules, especially also for production of microcapsules from melamine-formaldehyde polycondensates, are known.

In the process according to the invention for producing the microencapsulated fungicides, it is possible to use a solution of the fungicides in a water-immiscible solvent, which is then emulsified. Preferably, in the production of the microencapsulated fungicides, an aqueous suspension or emulsion of the fungicides themselves is used. The melamine-formaldehyde prepolymer dissolved in water is generally precipitated out by establishing an acidic pH, and precipitates on the surface of the solid or the liquid component of the emulsion or suspension. After the melamine-formaldehyde prepolymer has been deposited, the deposited resin has to be cured at elevated temperature. Preference is given to curing while stirring. The capsule can be cured, for example, by thermal treatment or by chemical treatment. Preferably, the capsule is cured by thermal treatment. The process of curing results in polymerization of as yet uncrosslinked or as yet unpolymerized groups. In the process according to the invention for producing the melamine-formaldehyde capsules, it is possible to initially charge the suspension of the fungicides and the prepolymer together with any auxiliaries, for example surfactants or protective colloids or else further amino resins, to heat the mixture and to adjust the pH, such that the resin precipitates out. But it is likewise possible first to initially charge the suspension or emulsion of the fungicides, optionally in a mixture with auxiliaries, then to adjust the pH, then to heat the mixture and to add the melamine-formaldehyde prepolymer. Preferably, an emulsion or suspension of the fungicides is first initially charged, the pH is adjusted, then the mixture is heated and then the melamine-formaldehyde prepolymer is added. Preferably, the microencapsulated fungicides produced by the process according to the invention are then cured at elevated temperature while stirring. The microencapsulated fungicides can subsequently be isolated by filtration and dried at room temperature or by gentle heating. But it is also possible to dry and to isolate the capsule material by spray-drying or freeze-drying. Preferably, the microencapsulated fungicides are separated off by filtration and then dried.

It is also possible to add further binders, protective colloids or auxiliaries known to those skilled in the art, for example fillers, surfactants, pigments, dispersants or thixotropic agents, to the melamine-formaldehyde prepolymers. Protective colloids used in the process according to the invention may be water-soluble polymers. If protective colloids are used, preference is given to using polyacrylates, partly hydrolysed polyvinyl acetate, polyvinyl alcohol, polyvinylpyrrolidone, cellulose ethers (tylose), for example methylcellulose, hydroxyethylcellulose or hydroxypropyl methylcellulose, polyacrylates, for example and with preference Coadis BR3 (from Coatex Inc.), starch, proteins, gum arabic, alginate, pectins, gelatins or mixtures of these compounds. The protective colloid used is more preferably a mixture of gum arabic and polyacrylate.

Solvents used for production of the emulsion are generally all water-immiscible solvents in which the azoles used in accordance with the invention dissolve. Solvents used for production of the emulsion are preferably aromatics, such as xylene, toluene or alkylnaphthalenes, chlorinated aromatics or chlorinated aliphatic hydrocarbons, such as chlorobenzenes, chloroethylenes or methylene chloride, aliphatic, cyclic, acyclic, linear or branched hydrocarbons, such as cyclohexane, paraffins or isoparaffins, mineral oil fractions or esters of mono- or polyhydric carboxylic acids or mixtures of such carboxylic acids, for example mixtures comprising diisobutyl adipate, diisobutyl glutarate, diisobutyl succinate or 2-ethylhexyl acetate, or alkyl phosphates, aryl phosphates or mixed alkyl aryl phosphates, for example tricresyl phosphate, triisobutyl phosphate, tri(ethylhexyl)phosphate, or acetophenone.

The process according to the invention for production of the microencapsulated fungicides can be conducted at any desired pressure. Preferably, the process according to the invention for production of the microencapsulated fungicides is conducted at standard normal pressure. In the process according to the invention for production of the microencapsulated fungicides, the temperature for deposition of the melamine-formaldehyde prepolymer may likewise be varied within a wide range; preferably, the deposition takes place at a temperature of 40-80° C.

In the process according to the invention for production of the microencapsulated fungicides, the curing of the capsules can be conducted at temperatures equal to or higher than the deposition temperatures. Preferably, the curing of the capsules takes place at elevated temperature. More preferably, the curing takes place at 42-95° C.; even more preferably, the curing of the capsules takes place at a temperature of 60° C. to 95° C.; and even more preferably, the curing takes place at 65° C. to 85° C. In the process according to the invention for production of the microencapsulated fungicides, the curing of the capsules requires a period of at least 1 hour up to several hours. Preferably, the curing in the process according to the invention takes place within 1-6 h, more preferably within 2 to 6 hours.

The pH at which the prepolymer is deposited can be determined experimentally in preliminary tests. Preferably, the pH values are between 2 and 4. The pH can be adjusted using either inorganic or organic acids, for example hydrochloric acid, sulphuric acid, phosphoric acid or citric acid, oxalic acid, acetic acid or formic acid or mixtures thereof.

The invention therefore encompasses a process for producing microencapsulated fungicides, in which at least one fungicide selected from the group of tebuconazole, propiconazole, thiabendazole and mixtures of these fungicides is mixed in an aqueous suspension or emulsion with at least one melamine-formaldehyde prepolymer and the prepolymer is deposited on the fungicides by altering the pH and is cured by thermal treatment. The production forms the melamine-formaldehyde polymer.

Preferably, the invention encompasses a process for producing the encapsulated fungicides, in which at least one fungicide selected from the group of tebuconazole, propiconazole and thiabendazole is heated in an aqueous emulsion at a pH of 2 to 4 at temperatures between 40 and 80° C. and, in a further step, is mixed with at least one melamine-formaldehyde prepolymer and the temperature is increased for curing.

It has additionally been found that the microencapsulated fungicides produced by the process according to the invention exhibit a particular improvement in leaching. This is especially true when the curing is conducted at a temperature of 60° C. to 95° C. for a period of 2 to 6 hours.

The microencapsulated fungicides feature a median diameter of 0.3 to 100 μm. Preferably, the microencapsulated fungicides have a median diameter of 1 to 60 μm. It is a further feature of the microencapsulated fungicides that less than 1% by weight of the particles are larger than 150 μm, measured by a screen analysis.

The compounds tebuconazole, propiconazole and thiabendazole are known to those skilled in the art.

The microencapsulated fungicides obtained in this way can either be incorporated directly into the sealing compounds or can first be converted to a solid or liquid formulation which is then incorporated into the scaling compounds.

If the dried microencapsulated fungicides are used directly to modify the silicone sealing compounds, the microencapsulated fungicides are used in an amount of 0.002% to 5% by weight. Preferably, the microencapsulated fungicides are used in an amount of 0.005% to 3% by weight and even more preferably in an amount of 0.01% to 2% by weight and even further preferably in an amount of 0.05% by weight to 1.0% by weight. The microencapsulated fungicides can be incorporated into the silicone sealing compounds by all processes known to those skilled in the art, for example by extrusion. The ratio of microcapsules to silicone sealing compound depends on the active ingredient content in the microencapsulated fungicides.

The dried microencapsulated fungicides can also be formulated as solids.

For this purpose, the microencapsulated fungicides are mixed with extenders, pigments or flow auxiliaries.

The extenders and pigments may be any commonly used inorganic or organic extenders and pigments, as also used in the silicone sealing compounds.

Preferably, the extenders are powdered clays, bentonites, mica, ground barytes, lightweight filler, calcium carbonate, titanium dioxide, aluminium hydroxide, kaolin, potash mica, ground slate, ground marble, talc, barytes, anhydrite, calcium sulphate dihydrate, magnesium carbonate, magnesium hydroxide, magnesium oxide or magnesite.

The pigments are preferably dyes based on synthetic iron oxide pigments, iron mica, titanium dioxide pigments, pigment black, or pearlescent pigments.

Flow auxiliaries used are preferably various silicas (hydrophilic, hydrophobic or fumed silicas or precipitated silicas), metal soaps, for example zinc stearate, magnesium stearate, calcium stearate or aluminium stearate.

The content of microencapsulated fungicides in the solid formulations may be varied within a wide range. In general, the solid formulations contain 3% to 99% by weight, preferably 5% to 95% by weight or very preferably 10% to 90% by weight of microencapsulated fungicides.

The invention therefore likewise encompasses solid formulations comprising at least one microencapsulated fungicide, wherein the fungicide is selected from the group of tebuconazole, propiconazole or thiabendazole or mixtures of these fungicides and the fungicide has been encapsulated with at least one melamine-formaldehyde resin, and at least one extender and at least one pigment and at least one flow auxiliary.

Liquid formulations used are solvent-based dispersions or pastes. They are composed of a solvent or diluent which is compatible with the silicone sealing compound and which does not dissolve the active ingredient out of the capsules, the dried capsule material and any further auxiliaries such as stabilizers, protective colloids and thickeners or thixotropic agents.

Solvents or diluents used may be any solvents which, firstly, are compatible with the sealing compounds and in which, secondly, the active ingredients do not dissolve. In general, aliphatic, alicyclic, cyclic or aromatic hydrocarbons are used for this purpose, preferably high-boiling aliphatic, alicyclic, cyclic or aromatic hydrocarbons having boiling points above 150° C. and most preferably alicyclic hydrocarbons having a boiling point greater than 150° C. Even further preferably, isoparaffins having boiling points above 200° C., for example Isopar V, are used.

The thickeners or thixotropic agents may generally be any substances capable of stabilizing dispersions of the capsules and any other fungicides in the abovementioned solvents or diluents, and hence of protecting them from sedimentation of the active ingredients. In the formulations, the thixotropic agents produce dispersions having a viscosity at 20° C. of 100 to 5000 mPas, preferably of 200 to 3000 mPas, measured with an applied shear force of 30 s⁻¹.

Preferably, the thickeners or thixotropic agents are inorganic thixotropic agents such as modified sheet silicates, fumed silicas or precipitated silicas, or organic thixotropic agents such as castor oil derivatives or mono-, di- or triglycerides of ricinoleic acid derivatives, especially mono-, di- or triglycerides of (12R)-cis-12-hydroxyoctadec-9-enoic acid, (9Z,12R)-12-hydroxyoctadec-9-enoic acid or 12-hydroxyoctadecanoic acid, esters or amides of ricinoleic acid or salts thereof, modified polyamides or fatty acid amides, modified polyamide waxes, such as, more particularly, Luvotix® HP from Lehmann & Voss, Hamburg, Germany, thixotropic polyolefins, such as, more particularly, Luvotix® P25x from Lehmann & Voss, Hamburg, Germany, urea derivatives or specially modified alkyd resins or compositions thereof.

More preferably, the thickeners or thixotropic agents are castor oil derivatives, for example hydrogenated castor oil, sulphated castor oil (CAS 8002-33-3), castor oil modified with polyamides or fatty acid amides, especially Luvotix® HT from Lehmann & Voss, Hamburg, Germany, inorganically modified castor oil, silicate-modified castor oil, such as, more particularly, Luvotix® ZR 50 from Lehmann & Voss, Hamburg, Germany, modified polyamides such as Rilanit® plus from Cognis, modified polyamide waxes, such as, more particularly, Luvotix® HP from Lehmann & Voss, Hamburg, Germany, thixotropic polyolefins, such as, more particularly, Luvotix® P25x or Luvotix® P50 from Lehmann & Voss, Hamburg, Germany, thixotropic alkyd resins which have urea structures, for example, or have been urethanized, or triglycerides of ricinoleic acid derivatives, especially triglycerides of (12R)-cis-12-hydroxyoctadec-9-enoic acid, (9Z,12R)-12-hydroxyoctadec-9-enoic acid or 12-hydroxyoctadecanoic acid, esters or amides of ricinoleic acid or salts thereof. The triglycerides of the ricinoleic acid derivatives, of ricinoleic acid or of hydrogenated ricinoleic acid (12-hydroxyoctadecanoic acid), esters thereof or amides thereof, and the salts thereof, can be used in compositions which optionally contain further saturated, unsaturated, branched or unbranched fatty acids. Preference is given to using the triglycerides of the ricinoleic acid derivatives, of ricinoleic acid or of hydrogenated ricinoleic acid (12-hydroxyoctadecanoic acid), esters thereof or amides thereof, and the salts thereof, in the inventive compositions.

A castor oil derivative used with very particular preference is hydrogenated castor oil (CAS No. 8001-78-3), as present, for example, in Luvotix® R from Lehmann & Voss, Hamburg, Germany.

It is also possible to use further thickeners or thixotropic agents or compositions composed of thixotropic agents. The thixotropic agents usable are generally commercially available and are normally also used for solvent-based paints to counter settling of the pigments.

Stabilizers used may be sterically hindered phenols, hindered amines, phosphites and phosphonates, hydroxylamines, lactones and benzofuranones, thioethers and thioesters or UV absorbers.

The content of microencapsulated fungicides in the liquid formulations may be varied within a wide range. In general, the liquid formulations contain 1% to 80% by weight, preferably 2% to 70% by weight or very preferably 5% to 60% by weight of microencapsulated fungicides.

More preferably, the liquid formulation contains
a) 2% by weight to 60% by weight of melamine-formaldehyde resin and
b) 0.25% by weight to 50% by weight of tebuconazole, propiconazole or thiabendazole or mixtures of these fungicides and
c) 10% by weight to 70% by weight of solvent and
d) 0.01% by weight to 5% by weight of thixotropic agent and
e) 0.01% by weight to 5% by weight of stabilizers,
   where the sum total of a), b), c), d) and e) is 100% by weight.

Even further preferably, the liquid formulation contains
a) 2% by weight to 18% by weight of melamine-formaldehyde resin and
b) 28% by weight to 48% by weight of tebuconazole, propiconazole or thiabendazole or mixtures of these fungicides and
c) 10% by weight to 70% by weight of solvent and
d) 0.01% by weight to 5% by weight of thixotropic agent and
e) 0.01% by weight to 5% by weight of stabilizers,
   where the sum total of a), b), c), d) and e) is 100% by weight.

Preferably, the liquid formulation contains
a) 5% by weight to 60% by weight of melamine-formaldehyde resin and
b) 0.25% by weight to 20% by weight of tebuconazole, propiconazole or thiabendazole or mixtures of these fungicides and
c) 10% by weight to 70% by weight of solvent and at least one further auxiliary,
d) 0.01% by weight to 5% by weight of thixotropic agent or
e) 0.01% by weight to 5% by weight of stabilizers or
   further auxiliaries, such as protective colloids or dispersants.

The invention therefore likewise encompasses liquid formulations comprising at least one encapsulated fungicide, wherein the fungicide is selected from the group of tebuconazole, propiconazole or thiabendazole or mixtures of these fungicides and the fungicide has been encapsulated with at least one melamine-formaldehyde resin, and at least one solvent, optionally at least one thixotropic agent and optionally further stabilizers.

The sealing materials modified with the microcapsules, in the broadest sense, are materials for sealing joins, gaps, apertures and the like.

The silicone sealing compounds may contain all the additives typical of sealing compounds, such as the typical thickeners, reinforcing fillers, crosslinkers, crosslinking catalysts, pigments, adhesives or other volume extenders.

The sealing compounds are modified with a sufficient amount of the encapsulated fungicides that, in general, an amount of active ingredient based on the total weight of the silicone sealing compound of 0.0001% to 1% by weight is present. Preferably, the amount of active ingredient is 0.0005% to 0.5% by weight, based on the total weight of the silicone sealing compound, and the amount of active ingredient is most preferably 0.001% to 0.3% by weight, based on the total weight of the silicone sealing compound. The exact amount needed can be determined by tests with the silicone sealing compounds to be modified in each case.

The encapsulated fungicides can optionally also be incorporated in what are called masterbatches. These are silicone sealing compounds which are first modified with a relatively high proportion of encapsulated fungicides and, in a second step, are brought to the abovementioned concentrations with further silicone sealing compound.

The content of microencapsulated fungicides in the masterbatches may be varied within a wide range. In general, the masterbatches contain 1% to 60% by weight, preferably 2% to 50% by weight or very preferably 5% to 40% by weight of microencapsulated fungicides.

The microencapsulated fungicides, and also the solid or liquid formulations produced therefrom, and also masterbatches can be incorporated into the silicone sealing compounds by known methods. The methods used are no different from the methods which are used by manufacturers of silicone sealing compounds to incorporate auxiliaries and pigments into the silicone sealing compounds. Usually, mixers, kneaders or extruders are used.

The microencapsulated fungicides, and also the solid and liquid formulations produced therefrom, may comprise further active ingredients, such as fungicides, algicides, bactericides or root penetration inhibitors, in order to improve the effect. They can be used in unencapsulated form or else encapsulated form.

Particularly favourable co-components in mixtures are, for example, the following compounds:

triazoles such as:
azaconazole, azocyclotin, bitertanol, bromuconazole, cyproconazole, diclobutrazole, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazole, penconazole, propiconazole, prothioconazole, simeoconazole, (+)-cis-1-(4-chlorophenyl)-2-(1H-1,2,4-triazol-1-yl)-cycloheptanol, 2-(1-tert-butyl)-1-(2-chlorophenyl)-3-(1,2,4-triazol-1-yl)propan-2-ol, tebuconazole, tetraconazole, triadimefon, triadimenol, triapenthenol, triflumizole, triticonazole, uniconazole or
imidazoles such as:
clotrimazole, bifonazole, climbazole, econazole, fenapanil, imazalil, isoconazole, ketoconazole, lombazole, miconazole, pefurazoate, prochloraz, triflumizole, thiazolcar 1-imidazolyl-1-(4′-chlorophenoxy)-3,3-dimethylbutan-2-one or
benzimidazoles such as:
thiabendazole, carbendazim, benomyl or fuberidazole;
pyridines and pyrimidines such as:
ancymidol, buthiobate, fenarimol, mepanipyrin, nuarimol, pyroxyfur, triamirol;
succinate dehydrogenase inhibitors such as:
benodanil, carboxim, carboxim sulphoxide, cyclafluramid, fenfuram, flutanil, furcarbanil, furmecyclox, mebenil, mepronil, methfuroxam, metsulfovax, nicobifen, penflufen, pyrocarbolid, oxycarboxin, shirlan, Seedvax;
naphthalene derivatives such as:
terbinafine, naftifine, butenafine, 3-chloro-7-(2-aza-2,7,7-trimethyl-oct-3-en-5-yne);
sulphenamides such as:
dichlofluanid, tolylfluanid, folpet, fluorofolpet, captan, captofol;
morpholine derivatives such as:
aldimorph, dimethomorph, dodemorph, falimorph, fenpropidin fenpropimorph, tridemorph, trimorphamid and the arylsulphonate salts thereof, for example p-toluenesulphonic acid and p-dodecylphenylsulphonic acid;
benzothiazoles such as:
2-mercaptobenzothiazole;
benzothiophene dioxides such as:
N-cyclohexyl-benzo[b]thiophene-S,S-dioxide carboxamide;
benzamides such as:
2,6-dichloro-N-(4-trifluoromethylbenzyl)benzamide, tecloftalam;
boron compounds such as:
boric acid, boric ester, borax;
isothiazolinones such as:
N-methylisothiazolin-3-one, 5-chloro-N-methylisothiazolin-3-one, 4,5-dichloro-N-octylisothiazolin-3-one, 5-chloro-N-octylisothiazolinone, N-octyl-isothiazolin-3-one, 4,5-trimethylene-isothiazolinone, 4,5-benzisothiazolinone;
thiocyanates such as:
thiocyanatomethylthiobenzothiazole, methylenebisthiocyanate;
quaternary ammonium compounds and guanidines such as:
benzalkonium chloride, benzyldimethyltetradecylammonium chloride, benzyldimethyldodecylammonium chloride, dichlorobenzyldimethylalkylammonium chloride, didecyldimethylammonium chloride, dioctyldimethylammonium chloride, N-hexadecycltrimethylammonium chloride, 1-hexadecylpyridinium chloride, iminoctadine tris(albesilate);
iodine derivatives such as:
diiodomethyl p-tolyl sulphone, 3-iodo-2-propynyl alcohol, 4-chlorophenyl-3-iodopropargylformal, 3-bromo-2,3-diiodo-2-propenyl ethylcarbamate, 2,3,3-triiodoallyl alcohol, 3-bromo-2,3-diiodo-2-propenyl alcohol, 3-iodo-2-propynyl n-butylcarbamate, 3-iodo-2-propynyl n-hexylcarbamate, 3-iodo-2-propynyl cyclohexylcarbamate, 3-iodo-2-propynyl phenylcarbamate;
phenols such as:
tribromophenol, tetrachlorophenol, 3-methyl-4-chlorophenol, 3,5-dimethyl-4-chlorophenol, dichlorphene, 2-benzyl-4-chlorophenol, triclosan, diclosan, hexachlorophene, methyl p-hydroxybenzoate, ethyl p-hydroxybenzoate, propyl p-hydroxybenzoate, butyl p-hydroxybenzoate, octyl p-hydroxybenzoate, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethylphenoxy)phenol and the alkali metal and alkaline earth metal salts thereof;
microbicides having an activated halogen group such as:
bronopol, bronidox, 2-bromo-2-nitro-1,3-propanediol, 2-bromo-4′-hydroxy-acetophenone, 1-bromo-3-chloro-4,4,5,5-tetramethyl-2-imidazolidinone, β-bromo-β-nitrostyrene, chloroacetamide, chloramin T, 1,3-dibromo-4,4,5,5-tetramethyl-2-imidazolidinone, dichloramin T, 3,4-dichloro-(3H)-1,2-dithiol-3-one, 2,2-dibromo-3-nitrile-propionamide, 1,2-dibromo-2,4-dicyanobutane, halane, halazone, mucochloric acid, phenyl 2-chlorocyanovinyl sulphone, phenyl 1,2-dichloro-2-cyanovinyl sulphone, trichloroisocyanuric acid;
pyridines such as:
1-hydroxy-2-pyridinethione (and their Cu-, Na, Fe, Mn, Zn salts), tetrachloro-4-methylsulphonylpyridine, pyrimethanol, mepanipyrim, dipyrithione, 1-hydroxy-4-methyl-6-(2,4,4-trimethylpentyl)-2(1H)-pyridine;
methoxyacrylates or the like, such as:
azoxystrobin, dimoxystrobin, fluoxastrobin, kresoxim-methyl, metominostrobin, orysastrobin, picoxystrobin, pyraclostrobin, trifloxystrobin, 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one (CAS No. 185336-79-2);
metal soaps such as:
salts of the metals tin, copper and zinc with higher fatty acids, resin acids, naphthenoic acids and phosphoric acid, for example tin naphthenate, tin octoate, tin 2-ethylhexanoate, tin oleate, tin phosphate, tin benzoate, copper naphthenate, copper octoate, copper 2-ethylhexanoate, copper oleate, copper phosphate, copper benzoate, zinc naphthenate, zinc octoate, zinc 2-ethylhexanoate, zinc oleate, zinc phosphate, zinc benzoate;
metal salts such as:
salts of the metals tin, copper, zinc, and also chromates and dichromates, for example copper hydroxycarbonate, sodium dichromate, potassium dichromate, potassium chromate, copper sulphate, copper chloride, copper borate, zinc fluorosilicate, copper fluorosilicate;
oxides such as:
oxides of the metals tin, copper and zinc, such as, for example, tributyltin oxide, Cu₂O, CuO, ZnO;
dithiocarbamates such as:
cufraneb, ferban, potassium N-hydroxymethyl-N′-methyl-dithiocarbamate, sodium dimethyldithiocarbamate, potassium dimethyldithiocarbamate, mancozeb, maneb, metam, metiram, thiram, zineb, ziram;
nitriles such as:
2,4,5,6-tetrachloroisophthalonitrile, disodium cyano-dithioimidocarbamate;
quinolines such as:
8-hydroxyquinoline and its copper salts;
other fungicides and bactericides such as:
bethoxazin, 5-hydroxy-2(5H)furanone, 4,5-benzodithiazolinone, 4,5-trimethylenedithiazolinone, N-(2-p-chlorobenzoylethyl)hexaminium chloride, 2-oxo-2-(4-hydroxyphenyl)acetohydroxycinnamoyl chloride, tris-N-(cyclohexyldiazeniumdioxy)aluminium, N-(cyclohexyldiazeniumdioxy)tributyltin or potassium salts thereof, bis-N-(cyclohexyldiazeniumdioxy)copper, iprovalicarb, fenhexamide, spiroxamine, carpropamid, diflumetorin, quinoxyfen, famoxadone, polyoxorim, acibenzolar S-methyl, furametpyr, thifluzamide, methalaxyl-M, benthiavalicarb, metrafenone, cyflufenamid, tiadinil, tea tree oil, phenoxyethanol, or
root penetration inhibitors such as:
esters of racemic 2-(4-chloro-2-methylphenoxy)propionic acid or of R-(+)-2-(4-chloro-2-methylphenoxy)propionic acid with, for example, polyethylene glycol, n-octanol, 2-ethylhexyl alcohol or else other relatively long-chain aliphatic alcohols.

The silicone sealing compounds modified with the microencapsulated fungicides are notable for good biological action against microorganisms, especially fungal mould.

Examples include fungal mould of the following genus:

Alternaria such as Alternaria tenuis,
Aspergillus such as Aspergillus niger,
Chaetomium such as Chaetomium globosum,
Coniophora such as Coniophora puetana,
Lentinus such as Lentinus tigrinus,
Penicillium such as Penicillium glaucum,
Polyporus such as Polyporus versicolor,
Aureobasidium such as Aureobasidium pullulans,
Sclerophoma such as Sclerophoma pityophila,
Trichoderma such as Trichoderma viridae.

The invention additionally encompasses the use of the microencapsulated fungicides for protection of the silicone sealing compounds against mould, wherein the fungicide is selected from the group of tebuconazole, propiconazole, thiabendazole and mixtures of these fungicides, and the fungicide has been encapsulated with at least one melamine-formaldehyde resin.

The invention likewise encompasses the use of the liquid and solid formulations for modification of silicone sealing compounds.

Additionally encompassed are also materials comprising the silicone sealing compounds modified with encapsulated fungicides.

The silicone sealing compounds modified with the microencapsulated fungicides, in spite of intensive water exposure, have long-lasting action. In addition, through the slower release of active ingredient, even in the case of low use concentrations, a long duration of action is found even in the case of increased contact with water. This slowed release results both in ecotoxicological and in environmental advantages. The amount of active ingredient that gets into the leaching water or the wastewater is distinctly reduced. It is immaterial here whether the microencapsulated fungicides or solid formulations or liquid formulations of these capsules are used. The silicone sealing compounds modified with the microencapsulated fungicides additionally have a high level of protection against microorganisms, especially fungal mould.

Furthermore, the inventive liquid formulations can be incorporated easily into the sealing compounds to be protected.

In addition, when the encapsulated fungicides are used, no changes are observed in the mechanical properties, the adhesion capacity and the curing time in the silicone sealing compounds.

### EXAMPLE

### Example 1

In a 1000 ml stainless steel beaker, 225 g of a 4% gum arabic solution, 4.5 g of a 50% Coadis BR3 solution, 302 g of demineralized water and 1.8 g of SILOFAM® SRE defoamer (Wacker) are mixed and adjusted to pH=2.99 with a 50% citric acid solution. This required 5.2 g of citric acid solution. To this are added 90 g of finely powdered tebuconazole, and the mixture is dispersed with an Ultraturrax at 10 400 rpm for 30 minutes.

The suspension thus obtained is transferred into a 1000 ml flange vessel and heated to 60° C. while stirring. Within 2 h, 90 g of a 1:1 Maprenal MF 921w/85WA (melamine-formaldehyde resin, Ineos Melamines)/water mixture are then added dropwise. The mixture is then heated to 70° C. and stirred at this temperature for another 4 h. After cooling, the mixture was filtered with suction, and the solids were washed with a little water and dried at 40° C. under reduced pressure. This gave 100.7 g of a white powder having a tebuconazole content of 72.9%.

### Example 2

In a 1000 ml stainless steel beaker, 22.5 g of a 4% gum arabic solution, 4.5 g of a 50% Coadis BR3 solution, 302 g of demineralized water and 2.7 g of SILOFAM® SRE defoamer (Wacker) are mixed and adjusted to pH=2.99 with a 50% citric acid solution. This required 5.36 g of citric acid solution. To this are added 90 g of finely powdered tebuconazole, and the mixture is dispersed with an Ultraturrax at 10 400 rpm for 30 minutes.

The suspension thus obtained is transferred into a 1000 ml flange vessel and heated to 60° C. while stirring. Within 2 h, 36 g of a 1:1 Maprenal MF 921w/85WA (melamine-formaldehyde resin, Ineos Melamines)/water mixture are then added dropwise. The mixture is then heated to 70° C. and stirred at this temperature for another 4 h. After cooling, the mixture was filtered with suction, and the solids were washed with a little water and dried at 40° C. under reduced pressure. This gave 96.05 g of a white powder having a tebuconazole content of 82.5%.

### Example 3

In a 2000 ml stainless steel beaker, 67.5 g of a 4% gum arabic solution, 13.5 g of a 50% Coadis BR3 solution, 900 g of demineralized water and 5.4 g of SILOFAM® SRE defoamer (Wacker) are mixed and adjusted to pH=2.99 with a 50% citric acid solution. This required 17.48 g. To this are added 270 g of finely powdered tebuconazole, and the mixture is dispersed with an Ultraturrax at 10 400 rpm for 30 minutes.

The suspension thus obtained is transferred into a 2000 ml flange vessel and heated to 60° C. while stirring. Within 2 h, 180 g of a 1:1 Maprenal MF 921w/85WA (melamine-formaldehyde resin, Ineos Melamines)/water mixture are then added dropwise. The mixture is then heated to 70° C. and stirred at this temperature for another 4 h. After cooling, the mixture was filtered with suction, and the solids were washed with a little water and dried at 40° C. under reduced pressure. This gave 305 g of a white powder having a tebuconazole content of 80.5%.

### Example 4

In a 1000 ml stainless steel beaker, 33.75 g of a 4% gum arabic solution, 6.75 g of a 50% Coadis BR3 solution, 450 g of demineralized water and 2.5 g of SILOFAM® SRE defoamer (Wacker) are mixed and adjusted to pH=2.99 with a 50% citric acid solution. This required 8.1 g. To this are added 135 g of finely powdered tebuconazole, and the mixture is dispersed with an Ultraturrax at 10 400 rpm for 30 minutes.

The suspension thus obtained is transferred into a 2000 ml flange vessel and heated to 60° C. while stirring. Within 2 h, 175 g of a 1:1 Maprenal MF 921w/85WA (melamine-formaldehyde resin, Ineos Melamines)/water mixture are then added dropwise. The mixture is then heated to 70° C. and stirred at this temperature for another 4 h. After cooling, the mixture was filtered with suction, and the solids were washed with a little water and dried at 40° C. under reduced pressure. This gave 182.5 g of a white powder having a tebuconazole content of 66.2%.

### General Method (GM1) for Production of a Formulation of Encapsulated and Unencapsulated Tebuconazole

For production of 13 g of formulation, 6 g of encapsulated or, as a comparison, unencapsulated tebuconazole and 7 g of Isopar V were weighed together with 12 mg of Luvotix R in a beaker and mixed with a dissolver disc at 3000 rpm for 10 min. In all cases, the product was a highly thixotropic paste. The active ingredient content was determined by means of HPLC.

### Formulations:

### Example 5

unencapsulated tebuconazole Content: 49.5% (HPLC)

### Example 6

encapsulated tebuconazole from Example 1 Content: 32.1% (HPLC)

### Example 7

encapsulated tebuconazole from Example 2 Content: 29.5% (HPLC)

### Example 8

encapsulated tebuconazole from Example 3 Content: 29.9% (HPLC)

### Example 9

encapsulated tebuconazole from Example 4 Content: 25.1% (HPLC)
General Method (GM2) for Production of Silicone Sheets Modified with Tebuconazole:

Unmodified silicone composition (OBI Classic, building silicone/transparent/neutral-crosslinking) was weighed into a plastic beaker. The tebuconazole formulation produced according to GM1 was added and incorporated with a Teflon-coated anchor stirrer for 20 min. 20 g of the silicone composition in each case were spread out to 15×7 cm with a putty knife and dried for 2 days. To determine the active ingredient concentration, a sheet was cut into small pieces with scissors and the tebuconazole content was tested by means of HPLC (start value).

General Method (GM2b) for Production of Silicone Sheets Modified with Tebuconazole:

Unmodified silicone composition (OBI Classic, building silicone/transparent/neutral-crosslinking) was weighed into a plastic beaker. Encapsulated or unencapsulated tebuconazole was added and incorporated with a Teflon-coated anchor stirrer for 20 min. 20 g of the silicone composition in each case were spread out to 15×7 cm with a putty knife and dried for 2 days. To determine the active ingredient concentration, a sheet was cut into small pieces with scissors and the tebuconazole content was tested by means of HPLC (start value).

### General Method (GM3a) for Determining the Leaching of Tebuconazole Out of Silicone Sheets:

To determine the leaching of encapsulated and unencapsulated tebuconazole, silicone sheets according to GM2 or GM2b were modified with 1000 ppm or 2500 ppm of encapsulated or unencapsulated tebuconazole. The sheets were then leached in a leaching chamber for 3 weeks. After one, two and three weeks, one sheet was removed and dried for 2 days. The sheet was cut into small pieces with scissors and the remaining tebuconazole content was determined by means of HPLC.

### General Method (GM3b) for Determining the Leaching of Tebuconazole Out of Silicone Sheets:

To determine the leaching of encapsulated and unencapsulated tebuconazole, silicone sheets according to GM2 or GM2b were modified with 1000 ppm or 2500 ppm of encapsulated or unencapsulated tebuconazole. The sheets were then leached in a leaching chamber for one week. The sheet was removed and dried for 2 days. The sheet was cut into small pieces with scissors and the remaining tebuconazole content was determined by means of HPLC.

### Example 10

### Study of the Leaching Characteristics of Unencapsulated Tebuconazole from Example 5

The formulation of unencapsulated tebuconazole was produced according to GM1 (Example 5). The silicone sheets were produced according to GM2. For the incorporation of 2500 ppm of tebuconazole, 124.687 g of silicone composition and 0.313 g of formulation were used. For the incorporation of 1000 ppm of tebuconazole, 124.875 g of silicone composition and 0.125 g of formulation were used. The leaching of the silicone sheets was effected according to GM3a. After leaching for 3 weeks, 100% (silicone sheet with 1000 ppm of tebuconazole) and 100% (silicone sheet with 2500 ppm of tebuconazole) tebuconazole had been washed out.

### Example 11

### Study of the Leaching Characteristics of Encapsulated Tebuconazole from Example 7

The formulation of encapsulated tebuconazole (Example 7; theoretical resin content 16.7%) was produced according to GM1. The active ingredient content, determined via HPLC, was 29.5%. The silicone sheets were produced according to GM2. For the incorporation of 2500 ppm of tebuconazole, 124.92 g of silicone composition and 1.077 g of formulation were used. For the incorporation of 1000 ppm of tebuconazole, 124.57 g of silicone composition and 0.428 g of formulation were used. The leaching of the silicone sheets was effected according to GM3a. After leaching for 3 weeks, 100% (silicone sheet with 1000 ppm of tebuconazole) and 90% (silicone sheet with 2500 ppm of tebuconazole) tebuconazole had been washed out.

### Example 12

### Study of the Leaching Characteristics of Encapsulated Tebuconazole from Example 6

The formulation of encapsulated tebuconazole (Example 6; theoretical resin content 31%) was produced according to GM1. The active ingredient content, determined via HPLC, was 32.1%. The silicone sheets were produced according to GM2. For the incorporation of 2500 ppm of tebuconazole, 124.026 g of silicone composition and 0.973 g of formulation were used. For the incorporation of 1000 ppm of tebuconazole, 124.61 g of silicone composition and 0.389 g of formulation were used. The leaching of the silicone sheets was effected according to GM3a. After leaching for 3 weeks, 28% (silicone sheet with 1000 ppm of tebuconazole) and 17% (silicone sheet with 2500 ppm of tebuconazole) tebuconazole had been washed out.

### Example 13

### Study of the Leaching Characteristics of Encapsulated Tebuconazole from Example 8

The formulation of encapsulated tebuconazole (Example 8; theoretical resin content 25%) was produced according to GM1. The active ingredient content, determined via HPLC, was 29.9%. The silicone sheets were produced according to GM2. For the incorporation of 2500 ppm of tebuconazole, 74.375 g of silicone composition and 0.625 g of formulation were used. For the incorporation of 1000 ppm of tebuconazole, 74.75 g of silicone composition and 0.25 g of formulation were used. The leaching of the silicone sheets was effected according to GM3b. After leaching for one week, 20% (silicone sheet with 1000 ppm of tebuconazole) and 15% (silicone sheet with 2500 ppm of tebuconazole) tebuconazole had been washed out.

### Example 14

### Study of the Leaching Characteristics of Encapsulated Tebuconazole from Example 9

The formulation of encapsulated tebuconazole (Example 9; theoretical resin content 39.3%) was produced according to GM1. The active ingredient content, determined via HPLC, was 25.1%. The silicone sheets were produced according to GM2. For the incorporation of 2500 ppm of tebuconazole, 74.375 g of silicone composition and 0.625 g of formulation were used. For the incorporation of 1000 ppm of tebuconazole, 74.75 g of silicone composition and 0.25 g of formulation were used. The leaching of the silicone sheets was effected according to GM3b. After leaching for one week, −2% (silicone sheet with 1000 ppm of tebuconazole) and 0% (silicone sheet with 2500 ppm of tebuconazole) tebuconazole had been washed out.

Tables 1 and 2 show the results of Examples 10, 11, 12, 13 and 14.

TABLE 1
(Release of tebuconazole from silicone sheets with 1000
ppm of tebuconazole from Examples 10, 11, 12, 13 and 14):

| | Theoretical resin content | | | | |
|---|---|---|---|---|---|
| | 0% | 16.7% | 25% | 31.0% | 39.3% |
| Leaching | Example | | | | |
| [weeks] | 10 | 11 | 13 | 12 | 14 |
| 1 | 99% | 59% | 20% | −9% | −2% |
| 2 | 100% | 95% | | 34% | |
| 3 | 100% | 100% | | 28% | |

The stated percentages indicate the amount of tebuconazole leached out, based on the amount of tebuconazole used in %.

TABLE 2
Release of tebuconazole from silicone sheets with 2500 ppm
of tebuconazole from Examples 10, 11, 12, 13 and 14:

| | Theoretical resin content | | | | |
|---|---|---|---|---|---|
| | 0% | 16.7% | 25% | 31.0% | 39.3% |
| Leaching | Example | | | | |
| [weeks] | 10 | 11 | 13 | 12 | 14 |
| 1 | 98% | 67% | 15% | 19% | 0% |
| 2 | 100% | 81% | | 21% | |
| 3 | 100% | 90% | | 17% | |

The stated percentages indicate the amount of tebuconazole leached out, based on the amount of tebuconazole used in %.

General Method (GM4) for Determining the Resistance of Silicone Sheets with 1000 ppm of Tebuconazole Against Fungal Mould:

The evaluation of the action of microorganisms on plastics—resistance to fungal mould—was effected to EN ISO 846 B. The test fungi used can be found in Table 3.

3 test specimens of each sample are tested (circular with diameter 3 cm).

The petri dishes filled with 15-20 ml of a glucose-salt agar are inoculated with the spore suspension (in each case 0.5 ml of a mix of equal parts of the spore suspensions mentioned in point 4).

The test specimens are placed individually onto the solidified agar and the closed petri dishes are then incubated in an incubation cabinet at 26° C.+/−1° C. for four weeks.

In a departure from the test method, the petri dishes are evaluated macroscopically and microscopically after 1 and 2 weeks.

TABLE 3
Test fungi used

| | | Spore concentration |
|---|---|---|
| Microfungus | Strain | [ml⁻¹] |
| Penicillium funiculosum | ATCC 36839 | 2.3 × 10⁷ |
| Chaetomium globosum | ATCC 6205 | 6.5 × 10⁵ |
| Gliocladium virens | ATCC 9645 | 2.5 × 10⁶ |
| Paecilomyces variotii | ATCC 18502 | 3.5 × 10⁶ |
| Aspergillus niger | ATCC 6275 | 8.8 × 10⁶ |

### Example 15

### Determination of the Resistance of Silicone Sheets with 1000 ppm of Tebuconazole Against Fungal Mould

The procedure for the biological study was according to GM5. The silicone sheets were produced with unencapsulated tebuconazole (Example 5), encapsulated tebuconazole (Example 8, theoretical resin content 25%; Example 9, theoretical resin content 39.3%) according to GM2b and leached according to GM3b.

Tables 4 and 5 show the results of Example 15.

TABLE 4
Resistance of the silicone sheets with 1000 ppm
of tebuconazole from Examples 10, 13 and 14 against
fungal mould to EN ISO 846 B without leaching

| Evaluation | Theoretical resin content | | |
|---|---|---|---|
| of fungal | 0% | 25% | 39.3% |
| growth | Example | | |
| [weeks] | 10 | 13 | 14 |
| 1 | 0/0/0 | 0/0/0 | 0/0/0 |
| 2 | 0/0/0 | 0/0/0 | 1*/1*/1* |

TABLE 5
Resistance of the silicone sheets with 1000 ppm of tebuconazole
from Examples 10, 13 and 14 against fungal mould to
EN ISO 846 B after leaching for one week

| Evaluation | Theoretical resin content | | |
|---|---|---|---|
| of fungal | 0% | 25% | 39.3% |
| growth | Example | | |
| [weeks] | 10 | 13 | 14 |
| 1 | 1/1/1 | 0/0/0 | 1/1/1 |
| 2 | 1*/2/1* | 0/0/0 | 1-2/2/1-2 |

Fungal growth scheme

| Growth | |
|---|---|
| intensity | Assessment |
| 0 | No growth apparent on microscope viewing |
| 1 | No growth apparent by the naked eye, but clearly |
| | apparent under the microscope |
| 2 | Growth apparent by the naked eye, up to 25% of the |
| | sample surface covered by growth |
| 3 | Growth apparent by the naked eye, up to 50% of the |
| | sample surface covered by growth |
| 4 | Considerable growth, more than 50% of the sample |
| | surface covered by growth |
| 5 | Significant growth, whole sample surface covered |
| | by growth |

1* means: Incipient growth at the edge.

1. Antifungal silicone sealing compounds comprising at least one microencapsulated fungicide, wherein the fungicide is selected from a group that includes tebuconazole, propiconazole, thiabendazole and mixtures of these fungicides, and the fungicide is encapsulated with an encapsulation material comprising at least one melamine-formaldehyde polymer.

2. The silicone sealing compounds according to claim 1, wherein the silicone sealing compounds are RTV-1 silicone sealing compounds.

3. The silicone sealing compounds according to claim 1, wherein the silicone sealing compounds are neutral-crosslinking RTV-1 silicone sealing compounds.

4. The silicon sealing compounds according to claim 1, wherein the fungicide is tebuconazole.

5. The silicone sealing compounds according to claim 1, wherein the compounds have a weight ratio of melamine-formaldehyde polymer to fungicide of 1:19 to 1:2.

6. The silicone sealing compounds according to claim 1, wherein the encapsulation material comprises at least 99% of melamine-formaldehyde polymer.

7. The silicon sealing compounds according to claim 1, wherein the silicone sealing compounds comprise at least one further fungicide selected from a group that includes azaconazole, cyproconazole, difenoconazole, epoxyconazole, hexaconazole, metconazole, propiconazole, tebuconazole, triadimefon, imazalil, prochloraz, carbendazim, thiabendazole and mixtures thereof.

8. A liquid fungicidal formulation comprising at least one microencapsulated fungicide and at least one solvent, wherein the fungicide is selected from a group that includes tebuconazole, propiconazole, thiabendazole and mixtures of these fungicides, and the fungicide is encapsulated with at least one melamine-formaldehyde resin.

9. A process for producing microencapsulated fungicides, the process comprising:
mixing at least one fungicide selected from a group that includes tebuconazole, propiconazole, thiabendazole and mixtures of these fungicides as an aqueous emulsion with at least one melamine-formaldehyde prepolymer;
altering the pH of the mixture to deposit the prepolymer on the at least one fungicide; and
curing the prepolymer by thermal treatment to form the melamine-formaldehyde polymer.

10. The process for producing microencapsulated fungicides according to claim 9, wherein the deposition is conducted at a temperature of 40° C. to 80° C.

11. The process for producing microencapsulated fungicides according to claim 9, wherein the prepolymer is cured at a temperature of 60° C. to 95° C.

12. The process for producing microencapsulated fungicides according to claim 11, wherein the prepolymer is cured for a period of 2 hours to 6 hours.

13. A method for protection of silicone sealing compounds against mould, the method comprising incorporating an encapsulated fungicide into the silicone sealing compounds, wherein the fungicide is selected from a group that includes tebuconazole, propiconazole, thiabendazole and mixtures of these fungicides, and the fungicide is encapsulated with at least one melamine-formaldehyde resin.

14. The method according to claim 13, wherein the silicon sealing compounds are neutral-crosslinking RTV-1 silicone sealing compounds.

15. The method according to claim 14, wherein the encapsulated fungicide comprises a liquid mixture of the encapsulated fungicide in a solvent.
